(19) United States
(12) Patent Application Publication
(10) Pub. No.: US 2025/0185048 A1
(43) Pub. Date: Jun. 5, 2025

(54) USER EQUIPMENT

(71) Applicant: Fraunhofer-Gesellschaft zur Förderung der angewandten Forschung e.V., München (DE)

(72) Inventors: Thomas WIRTH, Berlin (DE); Sarun SELVANESAN, Berlin (DE); Baris GÖKTEPE, Berlin (DE); Thomas FEHRENBACH, Berlin (DE); Thomas SCHIERL, Berlin (DE); Cornelius HELLGE, Berlin (DE)

(21) Appl. No.: 19/051,743

(22) Filed: Feb. 12, 2025

Related U.S. Application Data
(63) Continuation of application No. PCT/EP2023/071951, filed on Aug. 8, 2023.

(30) Foreign Application Priority Data
Aug. 12, 2022 (EP) 22190184.6

(51) Int. Cl. H04W 72/40; H04W 72/0446; H04W 72/0453

(52) U.S. Cl. CPC H04W 72/40; H04W 72/0446; H04W 72/0453

(57) ABSTRACT

User equipment, especially transmitter user equipment, configured to transmit a data packet using a data signal, e.g., PSCCH and PSSCH, using one or more certain subchannels or resource blocks in one or more certain slots using sidelink communication and expecting a feedback message in a feedback signal, e.g., in a PSFCH, from a receiver user equipment of the data packet, wherein the feedback signal is receivable within PSFCH candidates, at more than one time and/or frequency and/or cyclic shift locations. User equipment, especially receiver user equipment, configured to receive a data packet using a data signal using one or more certain subchannels or resource blocks in one or more certain slots using sidelink communication and to transmit a feedback message in a feedback signal to a transmitter user equipment, wherein the feedback signal is transmittable within PSFCH candidates at more than one time and/or frequency and/or cyclic shift locations.

### CROSS-REFERENCE TO RELATED APPLICATIONS

This application is a continuation of copending International Application No. PCT/EP2023/071951, filed Aug. 8, 2023, which is incorporated herein by reference in its entirety, and additionally claims priority from European Application No. 22190184.6, filed Aug. 12, 2022, which is also incorporated herein by reference in its entirety.

Embodiments of the present invention refer to user equipment, especially to a transmitter user equipment and a receiver user equipment. Further embodiments refer to a method for performing sidelink communication into a computer program. In general, embodiments refer to sidelink communication and the handling of feedback messages, e.g., in a PSFCH.

### BACKGROUND OF THE INVENTION

FIG. 9 is a schematic representation of an example of a terrestrial wireless network 100 including, as is shown in FIG. 9(a), the core network 102 and one or more radio access networks RAN₁, RAN₂, . . . . RAN_{N}. FIG. 9(b) is a schematic representation of an example of a radio access network RANₙ that may include one or more base stations gNB₁ to gNB₅, each serving a specific area surrounding the base station schematically represented by respective cells 106₁ to 1065. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 9(b) shows an exemplary view of five cells, however, the RANₙ may include more or less such cells, and RANₙ may also include only one base station. FIG. 9(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 9(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 9(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 9(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSCCH, carrying for example the downlink control information, DCI, the uplink control information, UCI, and the sidelink control information, SCI, and physical sidelink feedback channels, PSFCH, carrying feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 9 may be a heterogeneous network having distinct overlaid networks, e.g., a network of macro cells with each macro cell including a macro base station, like base station gNB₁ to gNB₅, and a network of small cell base stations, not shown in FIG. 9, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 9, for example in accordance with the LTE-Advanced Pro standard or the 5G or NR, new radio, standard.

In mobile communication networks, for example in a network like that described above with reference to FIG. 9, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 9. This is referred to as an “in-coverage” scenario. Another scenario is referred to as an “out-of-coverage” scenario. It is noted that “out-of-coverage” does not mean that the two UEs are not within one of the cells depicted in FIG. 9, rather, it means that these UEs

may not be connected to a base station, for example, they are not in an RRC connected state, so that the UEs do not receive from the base station any sidelink resource allocation configuration or assistance, and/or

may be connected to the base station, but, for one or more reasons, the base station may not provide sidelink resource allocation configuration or assistance for the UEs, and/or

may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 10 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 9. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 11 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 11 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 10, in addition to the NR mode 1 or LTE mode 3 UEs 202, 204 also NR mode 2 or LTE mode 4 UEs 206, 208, 210 are present. In addition, FIG. 11, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 10 and FIG. 11 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

The initial vehicle-to-everything (V2X) specification was included in 3GPP's LTE Release 14. The scheduling and assignment of resources have been modified according to the V2X requirements, while the original device-to-device (D2D) communication has been used as the basis of the design. 3GPP's Release 15 of the LTE V2X (also known as enhanced V2X or eV2X) was completed in June 2018, and Release 16, the first release of 5G NR V2X, was completed in March 2020. 3GPP Release 17 focuses on sidelink enhancements, with emphasis on power saving, enhanced reliability and reduced latency, to cater to not only vehicular communications, but also public safety and commercial use cases.

The new 3GPP Release 18 will focus on implementing sidelink on the unlicensed spectrum.

Below, the background for sidelink communication and feedback transmission will be given. The background is discussed in light of the present invention, thus, it is apparent that the disclosure of the background and especially the interpretation of the background is part of the disclosure of the present invention and not to be interpreted as conventional technology

Background regarding NR HARQ Feedback: In Release 16/17, NR V2X introduced the support of HARQ based transmissions, by the RX UE to the TX UE, confirming the receipt of a given transmission. The RX UE can transmit an ACK/NACK for unicast and groupcast (type 1) transmissions, as well as NACK-only for particular groupcast (type 2) transmissions. The RX UE transmits the HARQ feedback depending on whether it was able to decode the transport block successfully or unsuccessfully.

For the NACK-only operation for groupcast type 2, the advantage of using this is to reduce the number of feedback resources needed for transmitting the feedback, which is useful in cases when a large number of RX UEs need to send feedback to the same TX UE. Another feature that was introduced was the use of the minimum communication distance, where the RX UE would send the feedback to the TX UE only if they are within a predefined distance from each other. This is because the feedback is relevant to the TX UE only if the RX UE is within this distance in order to attempt a retransmission. When operating in Mode 1, the TX UE in turn has to inform the gNB via PUCCH/PUSCH of the status of the feedback since the resources were allocated by the gNB in the form of a configured or dynamic grant.

In order to transmit the feedback, the RX UE uses 1 bit from the Physical Sidelink Feedback Channel (PSFCH). The RX UE used the first PSFCH time slot that respected the below 2 conditions.

Currently the TX UE provides in the SCI the “PSFCH overhead indication”, which is

a parameter derived from the higher layer parameter sl-PSFCH-Period, which is a resource pool configuration parameter. This parameter informs the RX UE on the periodicity of PSFCH resources defined within the resource pool.

SI-MinTimeGapPSFCH is another higher layer parameter which is a resource pool

configuration parameter that defines the minimum time gap between the data transmission in the PSSCH and the feedback transmission in the PSFCH.

Background in Context of Rel-16 NR-U Channel Access: A channel access procedure is a procedure based on sensing that evaluates the availability of a channel for performing transmissions. The basic unit for sensing is a sensing slot with a duration Tₛᵢ=9 us. The sensing slot duration Tₛᵢ is considered to be idle if an eNB/gNB or a UE senses the channel during the sensing slot duration, and determines that the detected power for at least 4 us within the sensing slot duration is less than energy detection threshold X_{Thresh}. Otherwise, the sensing slot duration Tₛᵢ is considered to be busy.

A channel occupancy refers to transmission(s) on channel(s) by eNB/gNB/UE(s) after performing the corresponding channel access procedures in this clause.

A channel occupancy time refers to the total time for which eNB/gNB/UE and any eNB/gNB/UE(s) sharing the channel occupancy perform transmission(s) on a channel after an eNB/gNB/UE performs the corresponding channel access procedures described above. For determining a Channel Occupancy Time, if a transmission gap is less than or equal to 25 us, the gap duration is counted in the channel occupancy time. A channel occupancy time can be shared for transmission between an eNB/gNB and the corresponding UE(s).

### Background in Context of Types of Channel Access Procedures:

Type-1—Time duration that are sensed to be idle before transmissions is random. A gNB or a UE determines an initial counter N which is randomly selected between 0 and CWₚ, where CW_{min,p}≤CWₚ≤CW_{max,p},CW_{min,p} and CW_{max,p} are subject to CAPC. N can be decreased when channel is sensed to be idle for a certain period of time. Transmission can only take place when N reaches 0.

Type-2A—Time duration that are sensed to be idle before transmissions is deterministic. The channel needs to be idle for a sensing interval of 25 us.

Type-2B—Time duration that are sensed to be idle before transmissions is deterministic. The channel needs to be idle for a sensing interval of 16 us.

Type-2C—Does not sense the channel before transmission. Duration of the corresponding transmission is at most 584 us.

The above mentioned objective is solved by the subject matter of the independent claims.

### SUMMARY

An embodiment may have a user equipment, especially transmitter user equipment, configured to transmit a data packet, e.g. Transport Block, using a data signal, e.g. PSCCH and PSSCH, using one or more certain subchannels or resource blocks in one or more certain slots using sidelink communication and expecting a feedback message in a feedback signal, from a receiver user equipment of the data packet, wherein the feedback signal is receivable within PSFCH candidates, at more than one time and/or frequency and/or cyclic shift locations.

Another embodiment may have a user equipment, especially receiver user equipment, configured to receive a data packet, e.g. Transport Block, using a data signal, e.g. PSCCH and PSSCH, using one or more certain subchannels or resource blocks in one or more certain slots using sidelink communication and to transmit a feedback message in a feedback signal, e.g. in a PSFCH, to a transmitter user equipment, wherein the feedback signal is transmittable within PSFCH candidates at more than one time and/or frequency and/or cylic shift locations.

According to another embodiment, a method for performing sidelink communication may have the step of: transmitting a data packet, e.g. Transport Block, using a data signal, e.g. PSCCH and PSSCH, using one or more certain subchannels or resource blocks in one or more certain slots using sidelink communication and expecting a feedback message in a feedback signal, e.g. in a PSFCH, from a receiver user equipment of the data signal, wherein the feedback signal is receivable within PSFCH candidates, at more than one time and/or frequency and/or cyclic shift locations.

According to another embodiment, a method for performing sidelink communication may have the step of: receiving a data packet, e.g. Transport Block, using a data signal, e.g. PSCCH and PSSCH, using one or more certain subchannels or resource blocks in one or more certain slots using sidelink communication and transmitting a feedback message in a feedback signal, e.g. in a PSFCH, to the transmitter user equipment, wherein the feedback signal is transmittable within PSFCH candidates at more than one time and/or frequency and/or cyclic shift locations.

An embodiment provides a user equipment, especially a transmitter user equipment, which is configured to transmit a data packet, e.g., transport block (TB), using a data signal, e.g., PSCCH and PSSCH, using one or more certain subslots or resource blocks (RBS) in one or more certain (time) slots via sidelink communication. The user equipment is further configured to expect a feedback message in a feedback signal, e.g., in a PSFCH, from a receiver user equipment of the data packet. According to the disclosure, the feedback signal is receivable within PSFCH candidates at more than one time and/or frequency and/or cycle shift locations.

Another embodiment provides a user equipment, especially a receiver user equipment, configured to receive a data packet, e.g., transport block (TB), using a data signal, e.g., PSCCH and PSSCH, using one or more certain subslots or resource blocks (RBS) in one or more certain slots using sidelink communication. The receiver is configured to transmit a feedback message in a feedback signal, e.g., in a PSFCH, to a transmitter user equipment, wherein the feedback signal is transmittable within PSFCH candidates at more than one time and/or frequency and/or cycle shift locations.

Another embodiment provide a method for performing sidelink communication, comprising transmitting a data packet, e.g. Transport Block (TB), using a data signal, e.g. PSCCH and PSSCH, using one or more certain subchannels or resource blocks (RBs) in one or more certain slots using sidelink communication and expecting a feedback message in a feedback signal, e.g. in a PSFCH, from a receiver user equipment of the data signal, wherein the feedback signal is receivable within PSFCH candidates, at more than one time and/or frequency and/or cylic shift locations.

Another embodiment provides a method for performing sidelink communication comprising receiving a data packet, e.g. Transport Block (TB), using a data signal, e.g. PSCCH and PSSCH, using one or more certain subchannels or resource blocks (RBs) in one or more certain slots using sidelink communication and transmitting a feedback message in a feedback signal, e.g. in a PSFCH, to the transmitter user equipment, wherein the feedback signal is transmittable within PSFCH candidates at more than one time and/or frequency and/or cylic shift locations.

Another embodiment provides user equipment configured to transmit and/or receive a data signal, wherein the user equipment is configured to transmit a dummy signal in a current slot to keep a COT (continuous transmission) for the user equipment (itself) in the following slot or to keep a COT (continuous transmission) for another user equipment in the following slot.

According to another method for performing sidelink communication a data packet is transmitted in a current slot to keep the COT in the following slot.

According to further embodiments, the methods can be computer implemented.

### BRIEF DESCRIPTION OF THE DRAWINGS

Embodiments of the present invention will be detailed subsequently referring to the appended drawings, in which:

FIG. 1 shows a schematic legacy PSFCH having a periodicity of four slots and additional unlicensed repetitions introduced in case of LBT fails according to embodiments;

FIG. 2 shows a schematic representation of an illustration and mapping of data to PSFCH and associated repetitions according to embodiments;

FIGS. 3a & 3b show a concept to avoid “losing” the COT by introducing a dummy PSFCH (3a including a short LBT, FIG. 3b LBT less control) according to further embodiments;

FIG. 4 shows a schematic representation of a COT continuation signal sent by another UE, e.g., UE 2 according to further embodiments;

FIG. 5 shows a schematic representation for illustrating overprovisioning of PSFCH feedback to map to multiple LBT subbands with their own PSFCH according to further embodiments;

FIG. 6 shows a schematic representation illustrating PSFCH repeated in LBT subbands (PSFCH multiple locations) according to further embodiments;

FIG. 7 illustrates the PSFCH formula that gives a PSFCH location in multiple subbands according to further embodiments.

FIGS. 8a,b,c shows a schematic concept of repeating feedback data in accordance to three different streams (8a exponential, 8b Gaussian, 8c exponential until max with long tail) according to embodiments;

FIG. 9 shows a schematic representation of a terrestrial network (9a core network, 9b radio access network) to discuss implementations of the present embodiments;

FIG. 10 shows a schematic representation of an in coverage scenario;

FIG. 11 shows a schematic representation of an out of coverage scenario; and

FIG. 12 shows a schematic block diagram illustrating a computer system according to embodiments.

### DETAILED DESCRIPTION OF THE INVENTION

Below, embodiments of the present invention will subsequently be discussed referring to the enclosed figures. Here, identical reference numbers are provided to objects-identical or similar functions so that the description thereof is interchangeable and mutually applicable.

Before discussing the embodiments in detail, some definitions of terms used in context of the description of embodiments are provided:

Feedback message may be in the actual content of the HARQ feedback, e.g., ACK or NACK.

Feedback signal is the encoded feedback message, e.g., a PSFCH sequence

PSFCH is a physical channel over which the feedback signal is transmitted. It is a set of time/frequency resources.

PSFCH candidates may be a set of time/frequency/cyclic shifted resources where the TX UE expects the feedback signal in at least one of these candidates.

PSFCH occasion is the set of PSFCHs which are defined by the PSFCH periodicity and the first instance where the PSFCH is configured (starting of the PSFCH periodicity).

Embodiments of the present invention refer to user equipment, e.g., user equipment belonging to a communication system and/or user equipment performing sidelink communication. According to some embodiments unlicensed resources/unlicensed sidelink resources may be used, where typically LBT (listen before talk) is used to access the channel.

In general, the embodiments refer to the concept how a feedback message, e.g., a HARQ feedback can be exchanged between the transmitter UE, especially the UE transmitting a data packet, e.g., a transport block (TB), using a data signal, like PSCCH or PSSCH, and to a receiver UE, especially the UE receiving a data packet, e.g., transport block (TB), using a data signal, e.g., PSCCH and PSSCH. The transmission is performed from the transmitter UE to the receiver UE using one or more certain subchannels or resource blocks (RBS) in one or more certain slots using sidelink communication. The receiver UE is configured to transmit a feedback message in a feedback signal, e.g., in a PSFCH, to the transmitter UE. Vice versa, the transmitter UE is configured to expect or expects a feedback message in a feedback signal, e.g., in a PSFCH, from the receiver UE of the data packet.

If feedback is enabled for a sidelink transmission, since the TX UE cannot expect reception of the HARQ feedback on the same time slot as it transmitted the data, the RX UE will have to carry out LBT to determine whether it can transmit the feedback in a future slot, in order to check whether resources are available or not. If the TX and RX UE are sharing a COT, and the COT was initiated by the TX UE, then the RX UE need not perform LBT or just perform Type 2 LBT (shorter duration as compared to Type 1 LBT) in order to access the channel and transmit in the PSFCH.

In case of a so-called LBT failure, i.e., if the receiver UE tries to access a channel for transmitting the feedback message, e.g., PSFCH, but determines using LBT that the channel is not available or that the slot is not occupied by another UE providing a PSFCH, an approach is needed how to enable the receiver UE to transmit the feedback message. According to embodiments, the feedback signal is transmitted within at least one of so-called PSFCH candidates at more than one time and/or frequency and/or cycle shift locations. Consequently, the feedback signal can be received by the transmitter UE within the PSFCH candidates at the more than one locations, wherein the receiver UE can transmit the feedback signal within PSFCH candidates at more than one location. Thus, an enhanced approach how UEs can determine resources for transmitting feedback is determined, wherein feedback is enabled for the transmission. This includes the selection of resources on the feedback channel, the optimum usage of the channel, and the procedures that the UE would carry out in the event of a failed LBT.

According to embodiments, a periodicity of the PSFCH occasions is increased to define additional PSFCH candidates. For example, the time between PSFCH occasions is reduced.

According to embodiments, an increased PSFCH periodicity may be based on resource pool configurations.

Since the RX UE has to respect the minimum time gap after receiving payload data on the PSSCH, it would determine the first PSFCH which fulfils the minimum time gap. This results to only a single PSFCH where the feedback can be transmitted.

One way to improve the chances of the RX UE being able to find and use an available PSFCH instance is to ensure that for resource pools with PSFCH in the unlicensed band, the PSFCH periodicity is set to 1, which means PSFCH is defined in every time slot and further PSFCH are also allowed for the transmission of the feedback. In an embodiment, the PSFCH periodicity is increased and more than one PSFCHs are allowed to carry the feedback, in order to maximize the chances of the RX UE being able to find PSFCH instances. The periodicity is higher as compared to the current way of transmitting feedback in SL, e.g., reserve PSFCH resource in very other time slot, in every 3rd, 4th, etc., time slot.

Note, PSFCH occasions may be defined by the periodicity and an offset, i.e., existing PSFCHs. As discussed above, one or more PSFCH occasion may be determined as the PSFCH candidates. Note, a PSFCH candidate can be defined as a resource, where feedback may be sent. According to embodiments, a PSFCH candidate of the PSFCH candidates in a PSFCH time location may be used, where the PSFCH candidates are all PSFCH occasions that fall between a minimum and a maximum time gap relative to the data packet or PSSCH. According to embodiments, the maximum time gap is derived based on the PDP and/or a periodicity of TB being transmitted. Thus, maximum time gap between PSSCH and PSFCH may be used.

Currently, the RX UE identifies the PSFCH resource to transmit feedback based on the first timeslot that respects the sl-MinTimeGapPSFCH and the PSFCH periodicity. In order to provide the RX UE with more PSFCH occasions, we propose to introduce a maximum time gap between the PSSCH and the PSFCH. The RX UE is expected to transmit the feedback between the min and max time gaps.

The max time gap may be determined based on the PDB of the TB being transmitted. Hence, this parameter can be indicated in the SCI by the TX UE when transmitting the TB. It can also be a system level parameter or resource pool configuration where UEs can use appropriate resource pools based on the PDB and the min/max time gap. So that a transmitter can determine which data packet was acknowledged acknowledged or not-acknowledged for a given PSFCH, a PSFCH could comprise additional information.

According to embodiments, additional PSFCH occasions can be configured in time and/or frequency domain. Furthermore, in order to avoid modification of the existing PSFCH structure, additional PSFCH occasions or PSFCH resources can be configured by defining PSFCH repetitions, which are can be scheduled in between the current PSFCH occasions. With this, the PSFCH repetition can be configured differently, so that a possible receiver can distinguish which data packet was acknowledged or not-acknowledged for a given PSFCH repetition. In other words, each PSFCH repetition is uniquely linked to a certain PSFCH occasion and carries only feedback meant also for the PSFCH occasion.

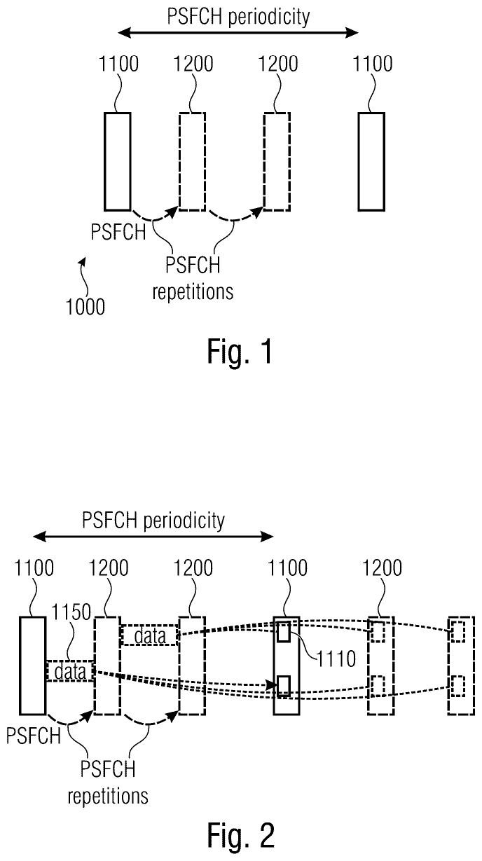

The extra repetitions between the already scheduled PSFCH resources is illustrated by FIG. 1. FIG. 1 illustrates a PSFCH transmission scheme 1000 comprising a conventional PSFCH periodicity of four slots for the legacy PSFCH 1100, wherein two additional unlicensed repetitions 1200 are introduced between the legacy PSFCH 1100 and can be used, e.g. in case of LBT failures.

In the case where UE1 has to transmit data to UE2 in the same time slot where UE1 has to receive a PSFCH repetition from another UE3, UE1 may prioritize the transmission of data or reception of the feedback depending on the priority of the transmissions. This can take place when the transmission and reception occurs in different LBT sub bands.

The UE will attempt to send PSFCH feedback in the intended PSFCH occasion and the associated repetitions of PSFCH occasions. The UE can either send the feedback multiple times or stop after a successful transmission. For SL-U, there can also be a fixed increased number of PSFCH repetitions, since LBT-failures in SL-U can occur and thus the likelihood of failed transmissions on the PSFCH is larger than in transmissions on a licensed carrier. This is illustrated by FIG. 2.

FIG. 2 illustrates a mapping of data portions 1150 transmitted in PSSCH between the PSFCH 1100 and PSFCH repetition 1200. As can be seen, the respective feedback is expected in some PSFCH repetitions 1200 subsequent to the data transmission 1150. The expected feedback is marked by reference numeral 1110.

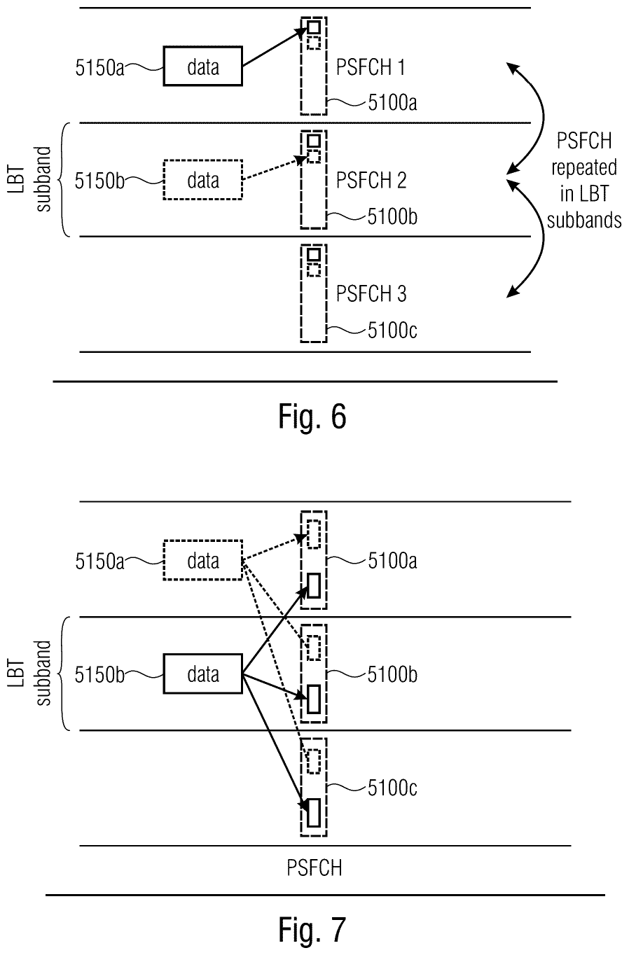

Expressed from another point of view, this means that for each PSFCH occasion, PSFCH resources or PSFCH repetitions are defined so that these form together the PSFCH candidates. The additional PSFCH resources are configured in a time domain as it is, for example, illustrated by FIGS. 1 and 2 and/or in a frequency domain, e.g. illustrated by FIGS. 5 and 6 and/or in a cycle shift domain. When having a look to the entire resource space, the additional PSFCH resources may be added in between the already available PSFCH occasions. This can, according to embodiments, be applied to the frequency domain so that the PSFCH candidates are located on more than one (frequency) subband. A subband may be a subchannel, LBT-subband, or (pre-) configured frequency resource. Thus, according to embodiments, the user equipment may be configured to use same subband or a different subband or multiple subbands or different multiple subbands for the PSFCH candidates. The principle of using different subbands or multiple subbands will be discussed in more detail with respect to FIGS. 5, 6 and 7 forming enhanced embodiments.

According to embodiments, the PSFCH candidates are defined by parameters which are indicated in an SCI by the transmitter user equipment, when transmitting a TB. Additionally or alternatively, the PSFCH candidates are defined by the minimum and/or maximum time gap derived by parameters that are indicated in the SCI. Expressed in other words, this means that the minimum and/or maximum time gap is derived by the parameters so that both, the transmitter as well as the receiver UE, can use this information to determine the PSFCH candidates.

In order to prevent another device to take over the spectrum, one of the cyclic shifts is—according to embodiments—used as a channel busy dummy signal by the UE that is transmitting data in the slot to keep the COT for the UE in the following slot. This is not necessary at the end of the COT. Another UE receiving the PSFCH would only have to perform a short LBT (Type 2 LBT) to regain channel access. Furthermore, this UE does not necessarily have to decode the PSFCH. In this way, no non-3GPP device could access the radio channel, since it would sense the channel to be occupied. The feedback to be send in this additional PSFCH can be HARQ-feedback and/or channel state information (CSI). This additional feedback can also be named a COT-continuation signal.

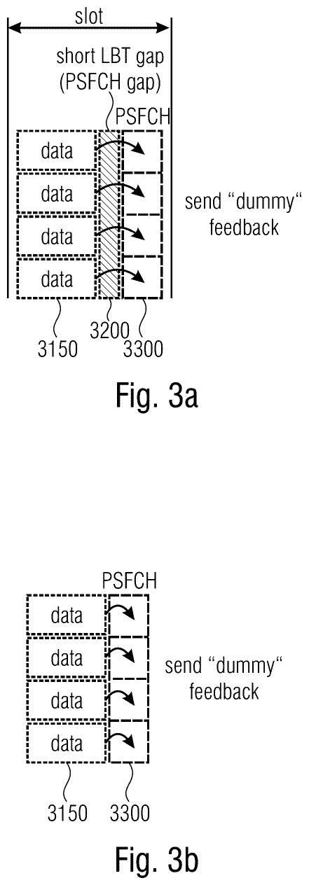

This is illustrated by FIGS. 3a and 3b both showing a slot in different subbands used for data transmission. The data transmission in FIGS. 3a and 3b packets are marked by the reference numeral 3150 and illustrated as being arranged in one time slot, but with multiple frequency slots. Subsequent to the data slot 3150 a dummy feedback/dummy PSFCH or general dummy signal marked by the reference numeral 330 is sent. In general, this means that user equipment, especially the transmitter user equipment, is configured to transmit a dummy signal in a current slot to keep COT (continuous transmission) for the user equipment in the following slot, or for the receiving user equipment sending the feedback signal. According to embodiments, the dummy signal can be a signal shift or sequence orthogonal to the HARQ feedback to be transmitted in the slot. This means that according to embodiments, the dummy signal is a sequence like a HARQ feedback or cyclic shift or a sequence orthogonal to the HARQ feedback to be transmitted in the same slot

According to embodiments, this principle may also be used without the aspect of providing additional PSFCH candidates. Thus, an embodiment forms a user equipment where the transmitter of the user equipment is configured to transmit a dummy signal in a current slot to keep a COT or a user equipment in a following slot or to keep a COT for another user equipment in the following slot.

Additionally, once a number (one or more) of PSFCH occasion or repetition was in a COT, future repetitions can, for example, be used for data. The number of PSFCH occasions/repetitions for a feedback can be configured or preconfigured.

The continuation signal can also be sent by another UE or RSU, in order to keep the COT for a future transmission. In this case, UE2 transmits a continuation signal, such that another UE, e.g., UE1, can continue its data transmission.

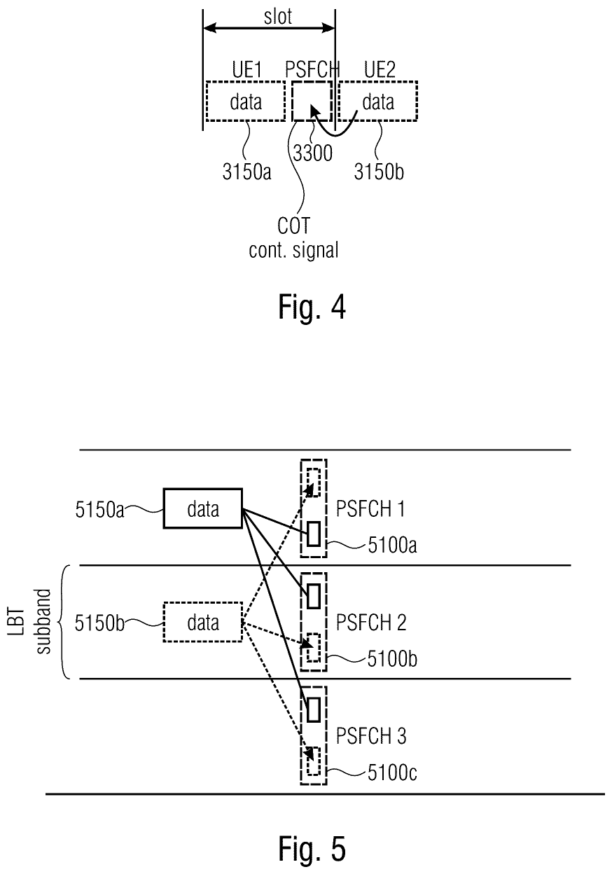

This is illustrated by FIG. 4 showing a data transmission 3150a followed by a dummy signal 3300 and followed by another data signal 3150b. The signal 3150b is a data packet transmitted in a subsequent slot by another UE, here UE2, wherein 3150a and 3300 is transmitted by a first UE UE1.

According to embodiments, the dummy signal is transmitted in the PSFCH before and/or after the PSSCH transmitted by the user equipment.

When assuming that the second UE may be the receiver UE sending its feedback, the transmitter UE (UE1) transmits the data portion 3150a and an enhanced dummy signal 3300 up to the next PSFCH candidate which is then used by the receiver UE. This means that, according to embodiments, the transmitter user equipment and the receiver user equipment are configured to use the same COT. According to embodiments, the receiver UE may perform type 1 or type 2 LBT, wherein the receiver user equipment may perform a transmission of the feedback signal without LBT or with LBT type 2. In this case, the TX UE initiates the COT for a data transmission, and the RX UE uses the same COT for transmitting the HARQ feedback oft he said data transmission.

The different COTs are used by transmitter user equipment and the receiver user equipment. For example, the transmitter user equipment may be configured to use type 1 or type 2 LBT, wherein the receiver user equipment is configured to use LBT before sending the feedback signal using different COT or different resources.

According to embodiments, different COTs are used by the transmitter user equipment (TX UE) and the receiver user equipment (RX UE); wherein the transmitter user equipment (TX UE) uses a first COT for a first data transmission to the receiver user equipment (RX UE); wherein the receiver user equipment (RX UE) uses a second COT for a further data transmission to the transmitter user equipment (TX UE), and transmits the feedback signal corresponding to the first data transmission in the second COT. In this case, the TX UE initiates the first COT for TB1, and the RX UE a second COT for TB2 to the TX UE, and then uses the second COT for transmitting the HARQ feedback corresponding to TB1.

Below, an approach called overprovisioning of PSFCH resources in the same time slot will be discussed. This overprovisioning of PSFCH resource can be combined with previously mentioned embodiments,.e.g. PSFCH repetitions, max/min time, resulting in an overprovisioning in time and frequency. Further this overprovisioning may be extended to the cyclic shift domain.

The RX UE can also be provided by multiple PSFCH occasions to use in order to attempt to send the feedback to the TX UE. One option is for the RX UE to have more than 1 PSFCH resource per time slot to utilize frequency diversity. This would still respect the time gap and the PSFCH periodicity and/or PSFCH repetitions, as mentioned earlier, but would provide the RX UE with more resources within the PSFCH to transmit the HARQ feedback to the TX UE. The exact mapping would have to be known to a receiver, either by configuration or by implicit specification, so that a potential receiver knows which feedback information is related to which data transmission or TB.

The overprovisioning of PSFCH feedback for multiple subbands is illustrated by FIG. 5.

FIG. 5 shows three subbands, where the PSFCH signals 5100a 5100b and 5100c are arranged in three different LBT subbands, so that feedback messages assigned to the two data packets 5150a and 5150b can be mapped. As can be seen, resulting from each data packet 5150a and 5150b three feedback messages are arranged in the PSFCH 5100b, 5100a and 5100c.

Nevertheless, the system can according to further embodiments prioritize to send the PSFCH within the same LBT subband which was also used for the associated data and restrict further PSFCH occasions within the same subband, or within at most x subbands, or within just neighbouring subbands, in order to reduce signalling efforts to a potential receiver, as well as to reduce the decoding efforts or decoding bandwidth needed at a potential receiver.

This is illustrated by FIG. 6. FIG. 6 shows a transmission of the two data packets 5150a and 5150b and a transmission of the feedback messages in the three PSFCHs 5100a, 5100b and 5100c. Here, a repetition in the different LBT subbands may be used.

Furthermore, the mapping can also avoid band-restrictions, in order to gain from frequency diversity, such that PSFCH occasions can be across a whole frequency bandwidth, or part of a larger set of subchannels, e.g., as depicted below, as illustrated by FIG. 7 showing the transmission 5150a and 5150b together with the transmission of the PSFCH as 5100a, 5100b and 5100c.

As can be seen, the embodiment of FIG. 6 uses just one PSFCH occasion for each feedback signal assigned to a data signal, wherein, according to an embodiment of FIG. 7, PSFCH occasions in different frequency bands are used and assigned to the respective data signals 5150a and 5150b.

To be able to send feedback with one or more LBT subbands, the PSFCH is on multiple subbands for each data transmission. According to embodiments, the following principles can be used if more than one LBT succeeds:

Transmit on all PSFCHs

Transmit on one or more:
a. Randomly,
b. Prioritizing the subband of the data transmission,
c. With a configured or pre-configured priority order,
d. On the same subband where the COT was shared by the TX UE,
e. With a restriction of how many subbands/other subbands to utilize.

According to embodiments, the feedback signal is transmitted on a subset of the PSFCH candidates, i.e., not in each possible PSFCH candidate. According to embodiments, the PSFCH candidates are prioritized by one or more the following principles:

randomly prioritizing subbands for the data packet;

using a configured or preconfigured priority order;

using a subbands which contains the data signal;

relative to the location of the data packet;

using the same subband where a COT is shared by the transmitter user equipment; and/or

restriction how many subbands or how many other subbands are utilized.

According to embodiments, this principle may be described to the concrete embodiment of the receiver user equipment transmitting its feedback as follows:

The receiver user equipment may use a second PSFCH candidate in case of LBT failure for the first PSFCH candidate of the PSFCH candidates.

Note, according to embodiments a receiver user equipment may be configured to use SCI or MAC CE for transmitting the feedback signal in case of a feedback failure.

Below, principles for using same or different COTs will be discussed. For example, the receiver user equipment receives the transmission in one COT and transmits the HARQ feedback in resources belonging to either the same COT or another COT.

According to another embodiments, the RX UE transmits the feedback in the same COT that the TX UE used for the data transmission. Here the RX UE can carry out type 2 LBT in order to reduce the time spent for performing LBT and ensuring that the PSFCH is available for transmission.

Yet another aspect here is that the RX UE can transmit the feedback to the TX UE in the same time slot that it already has a transmission scheduled, either to the same TX UE or to another UE. In this case, the RX UE would be using the COT carried out for another transmission, and use the PSCCH/PSSCH resources for the other transmission, but use the PSFCH resources of the time slot for transmitting the feedback to the TX UE. Here, the RX UE would have already carried out LBT Type 1/2 in order to determine the availability of the resources for the other transmission. In other words, the RX UE can use a COT that it initiated or is sharing (initiated by a third UE) for a transmission to a third UE, use the PSCCH/PSSCH in the time slot for a transmission to the third UE, but use the PSFCH for a transmission of the feedback to the TX UE.

This means that, according to embodiments, the transmitter user equipment and the receiver user equipment are configured to use the same COT. According to embodiments, the transmitter user equipment preforms type 1 or type 2 LBT (before a data transmission), wherein the receiver user equipment performs feedback transmission without LBT or with type 1 LBT.

According to embodiments, different COTs may be used. If the RX UE cannot transmit in the same COT as that of the TX UE, or does not have a transmission to another UE for which it has a COT, the UE will have to carry out LBT and determine another COT or another sub band/sub channel or another resource pool.

In general, this means that different COTs are used by the transmitter user equipment and a receiver user equipment. For example, the transmitter user equipment is configured to use type 1 or type 2 LBT, wherein the receiver user equipment is configured to use LBT before sending the feedback signal using different resources.

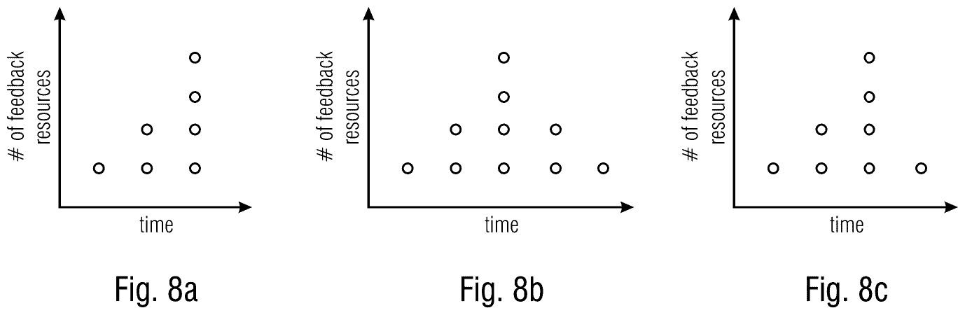

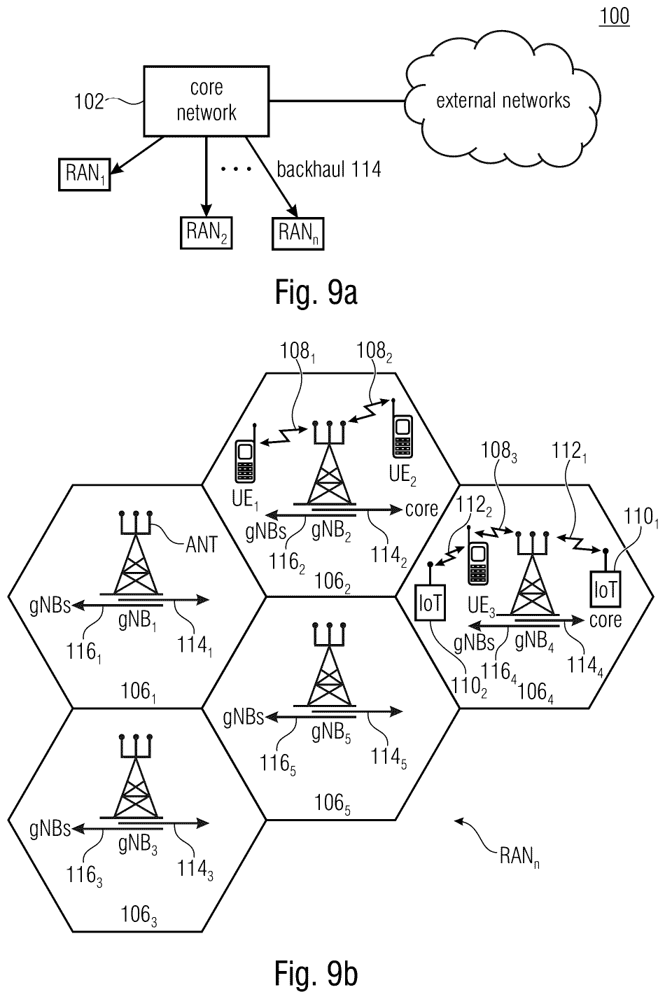

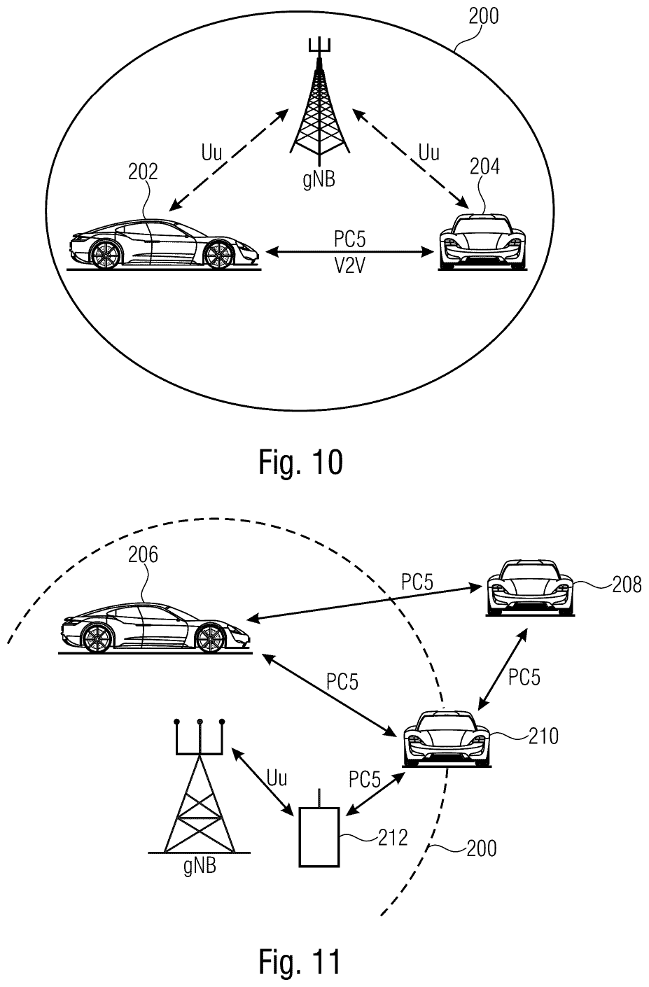

According to embodiments, the RX UE tries in x number of COTs where x increases according to a function, e.g., exponentially. For example, the UE makes the first attempt with one COT, then with an increased number of COTs for each subsequent attempt. Also other functions are possible, e.g., Gaussian feedback, as seen in FIG. 8.

FIGS. 8a to 8b shows the usage of different feedback resources from time to time, wherein in the subsequent time frames the resource is used, e.g., if in the poorest time frame an LBT failure occurs. As illustrated by FIGS. 8a, 8b and 8c, different schemes for the COTs may be used. All three FIGS. 8a, 8b and 8c plot different COTs/number of feedback resources over the time, where FIG. 8a shows an exponential increasing of the COTs, FIG. 8b shows a Gaussian increase of the COTs and FIG. 8c shows an exponential until max with low tail increasing of the COTs of type 1 LBT.

This means that, according to embodiments, the transmitter user equipment may be configured to transmit the feedback signal within the PSFCH according to a function. Here, the function may, for example, be defined by a cyclic shift pass for transmission of the feedback signal and/or by a cyclic shift pass for transmission of the feedback signal multiplexed in a physical resource block.

According to embodiments, the function may be a Gaussian function or an exponential function.

Furthermore, the UE can also multiplex a number of feedback signals within the PSFCH according to a function. This can be achieved by using cyclic shift/cyclic shift pairs for a PSFCH transmission. E.g., within the SL-PSFCH-Config, this can be signalled using the sl-NumMuxCS-Pair, which indicates the number of cyclic shift pairs to be used for a PSFCH transmission that can be multiplexed in a PRB. Current settings support the values n1, n2, n3 and n6. The higher the number of cyclic shift pairs, the more feedback data is multiplexed, but the less robust is the given code word. Thus, depending on the retransmission counter or remaining time until the maximum retransmission counter is reached, the sl-NumMuxCS-Pair can be configured, e.g., decreased, in order to make the feedback more robust, or increased, in order to allow to allow more feedback data being multiplexed in a single feedback resource.

According to further embodiments, the UE may perform an action of the failure of the HARQ feedback. There are two reasons why the TX UE would have assumed failed HARQ feedback. One is where the RX UE was able to decode the transmission from the TX UE successfully, but was not able to find a PSFCH resource for transmitting the feedback. The second is where the RX UE was not able to decode the transmission successfully, and has to send a NACK for a retransmission from the TX UE, but was not able to find a PSFCH resource for transmitting the feedback.

The reason the RX UE could not find PSFCH resources is due to repeated LBT failures and not being able to find available resources on the predetermined PSFCH time slots. In order to resolve this issue, there could be actions taken by the TX UE as well as by the RX UE

If PSFCH feedback failed a certain number of times and/or additionally the feedback can be piggybacked to a data transmission from Rx to Tx. In this case the HARQ feedback can be indicated in an SCI field or as a MAC CE.

Action taken by the transmitter user equipment, according to embodiments, one of the actions that the TX UE could do is to provide redundancies-indicate more than one PSFCH occasion to the RX UE to choose from. These occasions should be within the limitations of the time gap and the PSFCH periodicity of the resource pool, however, can include more than a single time slot. The TX UE can indicate these PSFCH occasions explicitly by using SCI format 2A/B/C, it can also implicitly indicate multiple PSFCH occasions by indicating the maximum time gap between the PSSCH and the PSFCH. This can also be a system level parameter, as discussed earlier.

The TX UE can according to embodiments monitor these n indicated PSFCH occasions where the RX UE can send the HARQ feedback. At the same time, the RX UE will now have n PSFCH occasions on which it can check for resource availability to transmit the HARQ feedback.

In yet another embodiment, if the TX UE indicates n PSFCH occasions to the RX UE, the RX UE can blindly use these resources without performing LBT. This can be provisioned when using the same COT initiated by the TX UE.

According to further embodiments, in Mode 1, the TX UE is expected to report the feedback to the gNB on a PUCCH resource determined by the sl-PSFCH-ToPUCCH-CG-Type1 parameter defined in the configured grant configuration, where the parameter indicates a slot offset between the PSFCH associated with the data transmission and the PUCCH occasion.

With the inclusion of n different PSFCH occasions, we propose that the TX UE can report the feedback to the gNB in one of 2 ways:

Report the feedback on the PUCCH after the offset from the actual PSFCH time slot in which it received the feedback from the RX UE.

Report the feedback on the PUCCH after the offset from the last of the n PSFCH candidates that have been defined previously. In this case, the PUCCH can be either after the max time gap or after the last PSFCH candidate that was defined by the TX UE.

Action Taken by the Receiver User Equipment: According to embodiments, in the case that the indicated PSFCH occasion was not available to the RX UE, but has to send the HARQ feedback to the TX UE, it can try to check for other PSFCH occasions that fit one or more of the following criteria:

Resources are available—LBT has to be successful,

Resources are from the same COT as initiated by the TX UE,

Time slot is within the PDB for the given transmission. The RX UE can stretch it to the very end of the PDB as long as the RX UE wants to send an ACK.

Priority of the transmission—if it is a higher priority, the RX UE would want to inform the TX UE ASAP.

The RX UE can take the following actions:

Send feedback on the same or on a different channel/subchannel/resource pool,

Send feedback using a non-SL-U carrier/resource pool,

Request the gNB to notify the TX UE about the status of the transmission, and if it was a NACK, accompany with a request to avoid transmission on an unlicensed carrier, e.g., resend on licensed band or duplicate data on licensed and unlicensed band:

a SFI (sidelink feedback indicator) can be use from the gNB to inform the Tx UE.

According to embodiments, this means that the receiver user equipment is configured to determine enhanced PSFCH occasions as follows:

available resources or available resources when LBT has been successful; and/or

resources from the same COT as initiated by the transmitter user equipment; and/or

time slot within the PDB for a given transmission; and/or

priority of transmission;

and/or

wherein the receiver user equipment is configured to take one of the following actions:

sending feedback on the same or on different channels/subchannels/resource pool;

sending feedback using non-SL-U carrier/resource pool;

requesting gNB to notify the transmitter user equipment about the status of transmission; and/or

requesting the gNB to notify the transmitter user equipment about the status of transmission so that the sidelink feedback indicator is used from the gNB to inform the transmitter user equipment.

Action After LBT Failure on PSFCH: According to embodiments, In the case of n-LBT failures, e.g., n-consecutive failures for a given resource/subchannel, check how the RX UE behaves in such a scenario:

Stop using PSFCH resource and refrain from transmitting HARQ feedback for this data, and possibly drop the transmission

Adapt HARQ behaviour, e.g., transmit exponential feedback (see figure above)

Look for a PSFCH in a licensed carrier,

Transmit feedback directly to a gNB (via Uu).

Switch/retransmit on licensed band.

In general, this means wherein the receiver user equipment is configured to perform for LBT failure one of the following actions:

stopping using PSFCH resource and refraining from transmitting HARQ feedback for the data signal;

adapting HARQ behavior;

transmitting a PSFCH in a license carrier;

transmitting feedback directly to gNB; and/or

switching/retransmitting unlicensed band.

Regarding the transmitter user equipment, it should be noted that same may be configured to indicate enhanced PSFCH occasions. According to embodiments, the receiver user equipment may be configured to use enhanced PSFCH occasions without listen before talk or by using listen before talk of type 1.

Below, an example configuration for NR-U is shown:

Phy-ParametersSharedSpectrumChAccess
The IE Phy-ParametersSharedSpectrumChAccess is used to convey the
physical layer capabilities specific for shared spectrum channel access.
Phy-ParametersSharedSpectrumChAccess information element

-- ASN1START
--

[symbol]

| | |
|---|---|
| Phy-ParametersSharedSpectrumChAccess-r16 ::= | SEQUENCE { |

--

[symbol]

| | | |
|---|---|---|
| rs-SINR- [symbol] -r16 | ENUMERATED {supported} | OPTIONAL, |

--

[symbol]

| | | |
|---|---|---|
| sp-CSI-ReportPUCCH-r16 | ENUMERATED {supported} | OPTIONAL, |

--

[symbol]

| | | |
|---|---|---|
| sp-CSI-DeportPUSCH-r16 | ENUMERATED {supported} | OPTIONAL, |

--

[symbol]

| | | |
|---|---|---|
| dynamic [symbol] -r16 | ENUMERATED {supported} | OPTIONAL, |

```
  -- [symbol]
  -- [symbol]
  -- [symbol]
  -- [symbol]
```

| | | |
|---|---|---|
| max-SR-HARQ-ACK-CSI-PUCCH-OncePerSlot-r16 | SEQUENCE { | |
| sameSymbol-r16 | ENUMERATED {supported} | OPTIONAL, |
| diffSymbol-r16 | ENUMERATED {supported} | OPTIONAL |

| | |
|---|---|
| } | OPTIONAL, |

--

[symbol]

| | | |
|---|---|---|
| max-SR-HARQ-ACK-PUCCH-r16 | ENUMERATED {supported} | OPTIONAL, |

```
  -- [symbol]
  -- [symbol]
```

| | | |
|---|---|---|
| max-SR-HARQ-ACK-CSI-PUCCH-MultiPerSlot-r16 | ENUMERATED {supported} | OPTIONAL, |

--

[symbol]

| | | |
|---|---|---|
| max-HARQ-ACK-PUSCH-DiffSymbol-r16 | ENUMERATED {supported} | OPTIONAL, |

--

[symbol]

| | | |
|---|---|---|
| pucch-Repetition-F1-2-4-r16 | ENUMERATED {supported} | OPTIONAL, |

--

[symbol]

| | | |
|---|---|---|
| type1-PUSCH-RepetitionMultiSlots-r16 | ENUMERATED {supported} | OPTIONAL, |

--

[symbol]

| | | |
|---|---|---|
| type2-PUSCH-RepetitionMultiSlots-r16 | ENUMERATED {supported} | OPTIONAL, |

--

[symbol]

| | | |
|---|---|---|
| pusch-RepetitionMultiSlots-r16 | ENUMERATED {supported} | OPTIONAL, |

--

[symbol]

| | | |
|---|---|---|
| pdsch-RepetitionMultiSlots-r16 | ENUMERATED {supported} | OPTIONAL, |

--

[symbol]

| | | |
|---|---|---|
| downlinkSPS-r16 | ENUMERATED {supported} | OPTIONAL, |

--

[symbol]

| | | |
|---|---|---|
| configuredUL-GrantType1-r16 | ENUMERATED {supported} | OPTIONAL, |

--

[symbol]

| | | |
|---|---|---|
| configuredUL-GrantType2-r16 | ENUMERATED {supported} | OPTIONAL, |

--

[symbol]

| | | |
|---|---|---|
| pre- [symbol] mptIndication-DL-r16 | ENUMERATED {supported} | OPTIONAL, |

...
}
-- [symbol]
-- [symbol] [symbol]
indicates data missing or illegible when filed

According to embodiments, the sidelink communication as described above uses an unlicensed band and/or a band needing LBT and/or a band needing LBT type 1 and/or type 2 when COT/continuous transmission sharing is used.

According to embodiments, the receiver unit is configured to carry out LBT to determine available resources for the feedback signal in a future time slot.

As discussed above, application fields of the above teachings are Sidelink communication systems, e.g., V2X, as in the context of cellular (e.g., 3G, 4G, 5G, or future), public safety communication systems, campus networks or ad-hoc communication networks.

Another embodiment refers to a communication system comprising at least two user equipments, advantageously user equipments performing a sidelink. Here, the first user equipment of the at least three user equipments may be a transmitter user equipment, wherein the second user equipment of the at least two user equipments may be a receiver user equipment.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

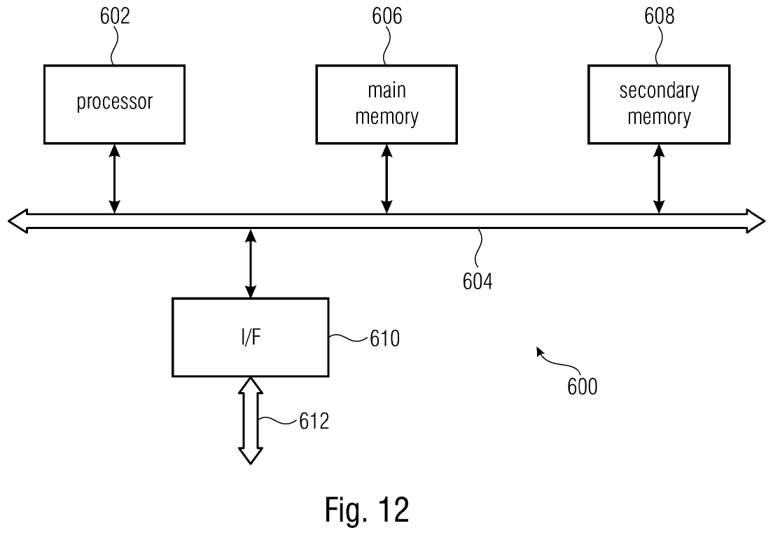

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

| | |
|---|---|
| V2X | Vehicle-to-Everything |
| 3GPP | Third Generation Partnership Project |
| D2D | Device-to-Device |
| AIM | Assistance Information Message |
| PC5 | Sidelink Interface |
| BS | Base Station |
| gNB | Evolved Node B (NR base station) |
| UE | User Equipment |
| SL | Sidelink |
| V2V | Vehicle-to-Vehicle |
| SIB | System Information Block |
| RB | Resource Block |
| PSCCH | Physical Sidelink Control Channel |
| PSSCH | Physical Sidelink Shared Channel |
| RRC | Radio Resource Control |
| SCI | Sidelink Control Information |

1. User equipment, especially transmitter user equipment, configured to transmit a data packet, e.g. Transport Block, using a data signal, e.g. PSCCH and PSSCH, using one or more certain subchannels or resource blocks in one or more certain slots using sidelink communication and expecting a feedback message in a feedback signal, from a receiver user equipment of the data packet,
wherein the feedback signal is receivable within PSFCH candidates, at more than one time and/or frequency and/or cyclic shift locations.

2. User equipment, especially receiver user equipment, configured to receive a data packet, e.g. Transport Block, using a data signal, e.g. PSCCH and PSSCH, using one or more certain subchannels or resource blocks in one or more certain slots using sidelink communication and to transmit a feedback message in a feedback signal, e.g. in a PSFCH, to a transmitter user equipment, wherein the feedback signal is transmittable within PSFCH candidates at more than one time and/or frequency and/or cylic shift locations.

3. User equipment according to claim 1, wherein more than one PSFCH occasion are determined as the PSFCH candidates.

4. User equipment according to claim 3, wherein the PSFCH candidates are all PSFCH occasions that fall between a minimum and a maximum time gap relative to the data packet.

5. User equipment according to claim 4, wherein the maximum time gap is determined based on the PDB and/or priority of TB being transmitted.

6. User equipment according to to claim 1, wherein the PSFCH candidates are defined by minimum and/or maximum time gap derived by parameters that are indicated in the SCI.

7. User equipment according to claim 1, wherein for each PSFCH occasion, additional PSFCH resources or PSFCH repetitions are defined so that the PSFCH occasion and the additional PSFCH resources or PSFCH repetitions form the PSFCH candidates.

8. User equipment according to claim 7, wherein the additional PSFCH resources are configured in a time domain and/or a frequency domain and/or cyclic shift domain.

9. User equipment according to claim 1, wherein the PSFCH candidates are located on more than one (frequency) subband.

10. User equipment according to claim 9, wherein the same subband or a different subband or multiple subbands or different multiple subbands are used.

11. User equipment according to claim 1, wherein the feedback signal is transmitted on a subset of the PSFCH candidates, and/or
wherein the PSFCH candidates are prioritized by one or more of the following principles:
randomly prioritizing subbands for the data packet;
using a configured or preconfigured priority order;
using a subband which comprises the data signal;
relative to the location of the data packet or time order of the PSFCH candidates;
using the same subband where a COT is shared by the transmitter user equipment; and/or
restriction on how many subbands or how many other subbands are utilized.

12. User equipment according to claim 1, wherein the receiving user equipment uses a second PSFCH candidate in case of LBT failure for the first PSFCH candidate of the PSFCH candidates.

13. User equipment according to claim 1, wherein the receiver user equipment is configured to use SCI or MAC CE for transmitting the feedback signal in case of a feedback failure.

14. User equipment according to claim 1, wherein the sidelink communication uses an unlicensed band and/or a band needing LBT and/or a band needing LBT Type 1 and/or Type 2 when COT (continuous transmission) sharing is used.

15. User equipment according to claim 1, wherein the receiver unit is configured to carry out LBT to determine available resources for the feedback signal in a future time slot.

16. User equipment according to claim 1, wherein transmitter user equipment and the receiver user equipment are configured to use the same COT; wherein the transmitter user equipment performs Type 1 or Type 2 LBT before a data transmission and wherein the receiver user equipment performs a transmission of the feedback signal without LBT or with LBT Type 2.

17. User equipment according to claim 1, wherein different COTs are used by the transmitter user equipment and the receiver user equipment; wherein the transmitter user equipment is configured to use Type 1 or Type 2 LBT and wherein the receiver user equipment is configured to use LBT before sending the feedback signal using a different COT.

18. User equipment according to claim 1, wherein the receiver user equipment is configured to use PSFCH without listen before talk or by using listen before talk of Type 2 of a shorter duration.

19. Method for performing sidelink communication, comprising:
transmitting a data packet, e.g. Transport Block, using a data signal, e.g. PSCCH and PSSCH, using one or more certain subchannels or resource blocks in one or more certain slots using sidelink communication and expecting a feedback message in a feedback signal, e.g. in a PSFCH, from a receiver user equipment of the data signal, wherein the feedback signal is receivable within PSFCH candidates, at more than one time and/or frequency and/or cyclic shift locations.

20. Method for performing sidelink communication comprising:
receiving a data packet, e.g. Transport Block, using a data signal, e.g. PSCCH and PSSCH, using one or more certain subchannels or resource blocks in one or more certain slots using sidelink communication and transmitting a feedback message in a feedback signal, e.g. in a PSFCH, to the transmitter user equipment, wherein the feedback signal is transmittable within PSFCH candidates at more than one time and/or frequency and/or cyclic shift locations.
